(19) United States
(12) Patent Application Publication
(10) Pub. No.: US 2013/0152039 A1
(43) Pub. Date: Jun. 13, 2013

(54) PROJECT SPECIFIC SOFTWARE DELIVERY PLANNING

(71) Applicant: ANDREAS KEMMLER, Boennigheim (DE)

(72) Inventor: ANDREAS KEMMLER, Boennigheim (DE)

(21) Appl. No.: 13/316,576

(22) Filed: Dec. 12, 2011

(51) Int. Cl. G06F 9/44

(52) U.S. Cl. 717/101

(57) ABSTRACT

Various embodiments of systems and methods for project specific software delivery planning are described herein. Development objects used by development projects and dependent development objects that depend on one or more of the development objects are determined. Dependency levels are assigned to the development projects based on one or more of the development objects that cause dependency. The dependency levels comprise a first dependency level indicating two or more of the development projects changed a same development object and a second dependency level indicating a first development object changed by a first development project depends on a second development object changed by a second development project. A list of the development projects, the dependency levels assigned to the development projects, and the development objects causing the dependency are then displayed.

### FIELD

The field relates generally to software delivery methods. More particularly, the field relates to planning and delivery of new software functionalities.

### BACKGROUND

Software products typically have scope for continuous improvement. Once a software product is delivered and operational, new functionalities can be developed. New functionalities, among several other benefits, can provide additional features, improve performance of the software, or address customer needs. These new functionalities can be delivered along with a new version of a software product. However, some software products such as, for example, Enterprise Resource Planning (ERP) products, are complex and delivery of an entire ERP product for the sake of new software functionalities may not be a feasible option.

One way of simplifying the way customers manage and deploy new software functionality for complex software products is by using enhancement packages (EHP). Customers can selectively implement these software functionalities and activate the software upon business demand. As a result, customers can isolate the impact of software updates from rolling out new functionality and bring new functionality online faster through shortened testing cycles. Customers can choose the software components they want to update in their systems depending on the new or extended functionality. Therefore, compared to the release upgrades known in the past, an EHP update affects only the area in the system where customers need innovations.

Enhancement packages have a time line and an EHP usually contains a new version (containing new functionalities) of each software component which has to be maintained until the end of contractually agreed maintenance period. Therefore, from the perspective of a software developing company, it is desirable to have less number of source code versions. On the other hand, it is desirable to offer innovations in the form of new functionalities as fast as possible. Also, each area of a complex product (e.g., Human Resource, Financial, or Retail, etc., of an ERP product) may have its own customer segments, innovative ideas, and preferred timelines to deliver new functionalities. Existing delivery methods cannot meet these challenges because an upgrade or an EHP has a timeline for release and each area of a product has to stick to that timeline. Functionalities belonging to a particular area that are ready for delivery have to wait for the common shipment date. Functionalities belonging to another area that are not ready for delivery by the shipment date may have to wait for a next shipment date.

It would therefore be desirable to provide shipment flexibility for different areas of a software product.

### SUMMARY

Various embodiments of systems and methods for project specific software delivery planning are described herein. Development objects used by development projects and dependent development objects that depend one or more of the development objects are determined. Dependency levels are assigned to the development projects based on one or more of the development objects that cause dependency. The dependency levels comprise a first dependency level indicating two or more of the development projects changed a same development object and a second dependency level indicating a first development object changed by a first development project depends on a second development object changed by a second development project. A list of the development projects, the dependency levels assigned to the development projects, and the development objects causing the dependency are then displayed.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates a block diagram of components of an enhancement package of an ERP system, according to one embodiment.

FIG. 2 is a block diagram of a method for project-specific software delivery planning, according to one embodiment.

FIG. 3 illustrates a user interface for displaying development projects, development objects causing dependency, dependency levels, shipment cluster assignment and preconditions, according to one embodiment.

FIGS. 4A-4H illustrate different types of dependency situations, according to one embodiment.

FIGS. 5A and 5B illustrate a flow diagram of a shipment cluster monitor, according to one embodiment.

FIG. 6 illustrates a block diagram of project-specific software delivery in comparison with enhancement packages, according to one embodiment.

FIG. 7 is a block diagram of an exemplary computer system according to one embodiment.

### DETAILED DESCRIPTION

Embodiments of techniques for project specific software delivery planning are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

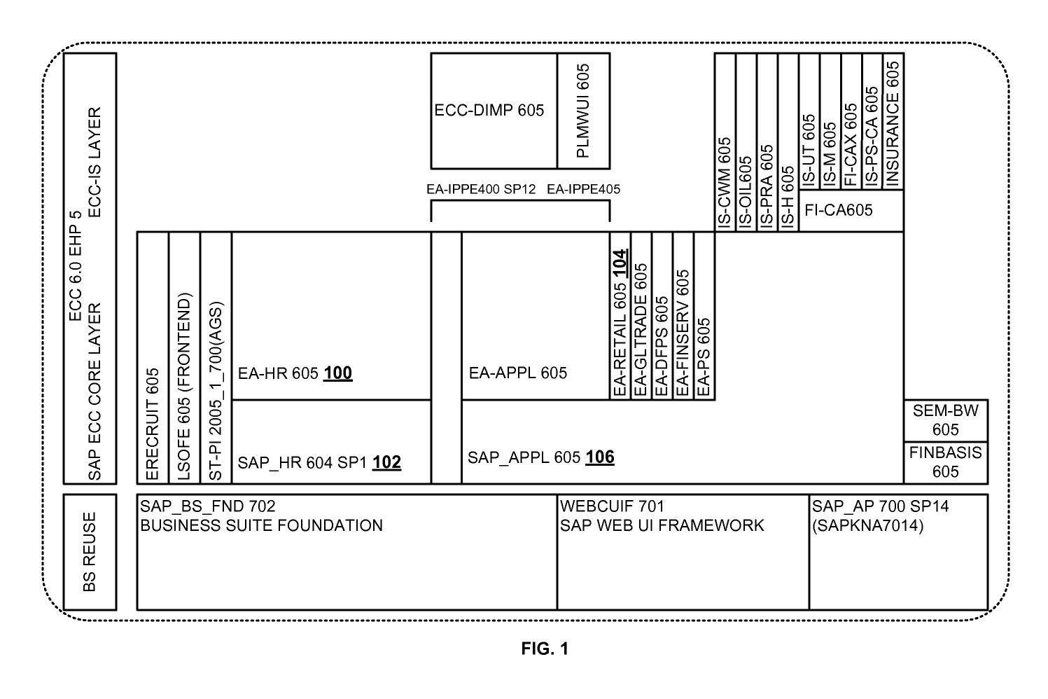

FIG. 1 illustrates software components of an enhancement package (EHP) of an ERP system. The ERP system is SAP® ERP Central Component (ECC), a product of SAP AG of Walldorf, Germany. An ERP system includes several modules or areas such as, for example, Human Resources, Finance, Production Planning, Material Management, Sales and Distribution. An ERP system includes several relatively decoupled software components. Each block in the FIG. 1 represents a decoupled software component, which can be installed separately by customers. For example, the “EA-HR 605” 100 and “SAP_HR 604 SP1” 102 are decoupled software components of a Human Resources (HR) module. Customers interested in innovations from Human Resources will install HR software components, i.e. “EA-HR 605” 100 and “SAP_HR 604 SP1” 102. Customers interested in innovations from the retail business will install retail-related software components, e.g., “EA-Retail 605” 104, in addition to any underlying components such as “SAP_APPL 605” 106. Although EHP is one of the useful ways of delivering upgrades or new versions, there are limitations as discussed previously. For example, an EHP has a shipment date and new functionalities have to wait for that shipment date even when they are ready. Also, functionalities that are not ready for delivery by a shipment date would have to wait for a next shipment date.

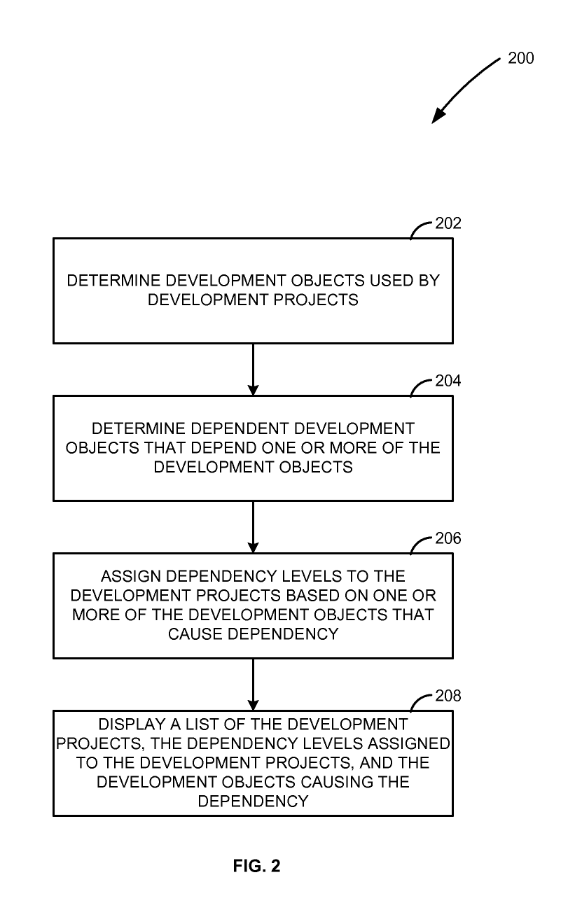

FIG. 2 illustrates an embodiment of a method 200 for project-specific software delivery planning The method enables shipment flexibility for new functionalities. One or more project development teams may be involved in development of a new functionality for a software module (e.g., a module of ERP system). Development of a new functionality is treated as a development project, which can be taken care of one or more development teams. A development project includes one or more development objects. Development objects are the individual parts of an object-oriented programming language-based application, e.g., Advance Business Application Programming (ABAP) application. Some examples of development objects are programs such as reports, transactions, and function modules. Other examples of development objects include program components such as events, screens, menus, and function modules. Objects that are shared by programs are also called development objects. These objects include database fields, field definitions, and program messages. In one embodiment, a development object is a component of an application program that is stored as a separate unit.

At 202, development objects which are used by development projects are determined. Development teams use a development system during the course of project development. A development system helps in organizing development projects and transporting changes between systems in a system landscape. Data about development projects is entered into the development system. Also, development data may need to be transported from one development system to other system. For example, development data is transferred from the development system to a consolidation system, which is used by software production units to build shipments. Development data captures various data such as objects used by a project, objects that are changed by a project, objects that are corrected by a project, etc. Therefore, this development data is used to determine the development projects and the development objects that are used by the development projects.

In one embodiment, one or more development transports are assigned to a development project to capture development data. A development transport includes data about the development objects used by a particular development project. Development transports are used to transport the developments objects of a development project from the development system to other systems such as a consolidation system, as cited previously, and quality assurance systems or testing systems. Consider a development project in Human Capital Management (HCM) module of an ERP system is about Data Privacy Enhancements. A list of development transports for this project is presented in Table 1 below, as an example:

TABLE 1

| Development | |
|---|---|
| Transport | Description |
| EH5K037934 | HCM Data Privacy enhancements - ECM |
| | Documentation |
| EH5K038015 | HCM Data Privacy enhancements - reqdb |
| EH5K037943 | HCM Data Privacy enhancements - REQ_DB changes |
| EH5K037738 | HCM Data Privacy enhancements - For Documentation |
| EH5K037623 | HCM Data Privacy enhancements - sel. Screen |

Five development transports are assigned to the HCM Data Privacy enhancements project. A development transport is assigned to a part or a task of the HCM Data Privacy enhancements project. For example, EH5K037623 development transport is assigned to “sel. Screen” portion of the HCM Data Privacy enhancements project. A development transport includes the data about the development objects that belong to a project. For example, as shown in Table 2 below, EH5K037623 development transport includes a list of development objects that belong to the HCM Data Privacy enhancements project.

TABLE 2

| | |
|---|---|
| Report Source Code | LIMU REPS RPASR_EREC_WRITE |
| Report Source Code | LIMU REPS RPASR_PA_WRITE |
| Report Source Code | LIMU REPS RPASR_PD_WRITE |
| Report Source Code | LIMU REPS RPT_REQUEST_WRITE |
| Report Texts | LIMU REPT RPT_REQUEST_WRITE |

Other development transports assigned to the HCM Data Privacy enhancements project also include a list of development objects belonging to HCM Data Privacy enhancements project. Therefore, by collecting the development transports assigned to the HCM Data Privacy enhancements project, a list of the development objects assigned to the HCM Data Privacy enhancements project is obtained. Similarly, development transports of other development projects are collected to determine the development objects that belong to respective development projects. This will give a list of development objects for each development project.

A development object may use one or more other development objects. The development objects that use other development objects are called dependent development objects. At 204, such dependent development objects are determined. Consider that development object 27 depends on development objet 6, which in turn depends on development object 1. Both development object 6 and 27 are dependent development objects. Development objects 1, 4, 7, and 15 can belong to project 1 and development objects 2, 5, 6, 22, and 27 belong to development project 2. Dependent development objects can therefore depend on development objects within the same development project or a different development project.

At 206, dependency levels are assigned to the development objects based on the development objects that cause dependency. A dependency between two development projects exists when at least one development object belongs to both of the affected projects. However, all dependencies caused by development objects may not be severe. Some dependency relationships can be easy to handle and can be overcome while others cannot be overcome. Therefore, dependency levels are assigned to the development projects for expressing degree of dependency. This will help project teams to see which dependencies are severe and which are easy to solve. In one embodiment, a first dependency level and a second dependency level are assigned. The first dependency level is assigned to development projects which changed a same development object. In such case, it may be difficult to cut the dependency. For example, if the development object ‘10’ is changed by a development project ‘x’ and a development project ‘y,’ then the first dependency level is assigned to both the development projects ‘x’ and ‘y.’ If a first development object (e.g., DO1) that is changed by a first development project (e.g., P15) depends on a second development object (e.g., DO5) that is changed by a second development project (e.g., P24), then both the first and second development projects are assigned a second dependency level. In this case, it may be possible to resolve the dependency.

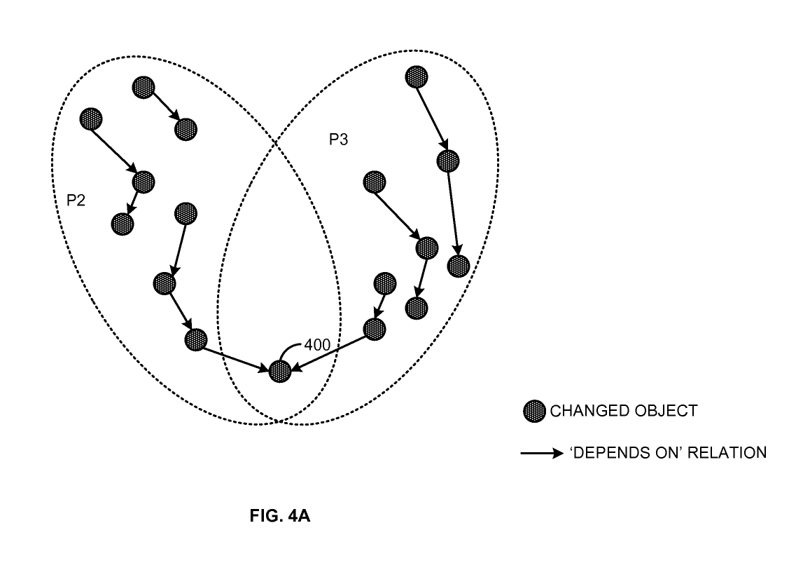

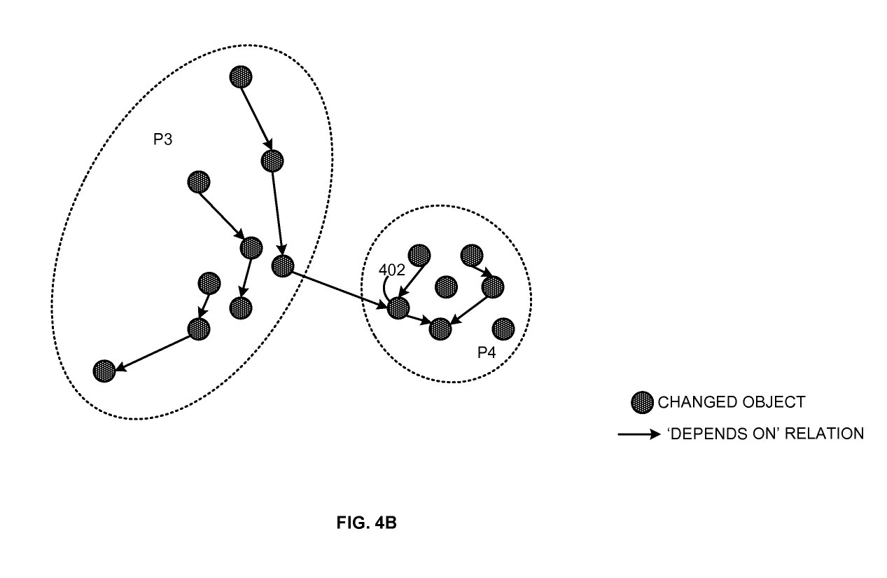

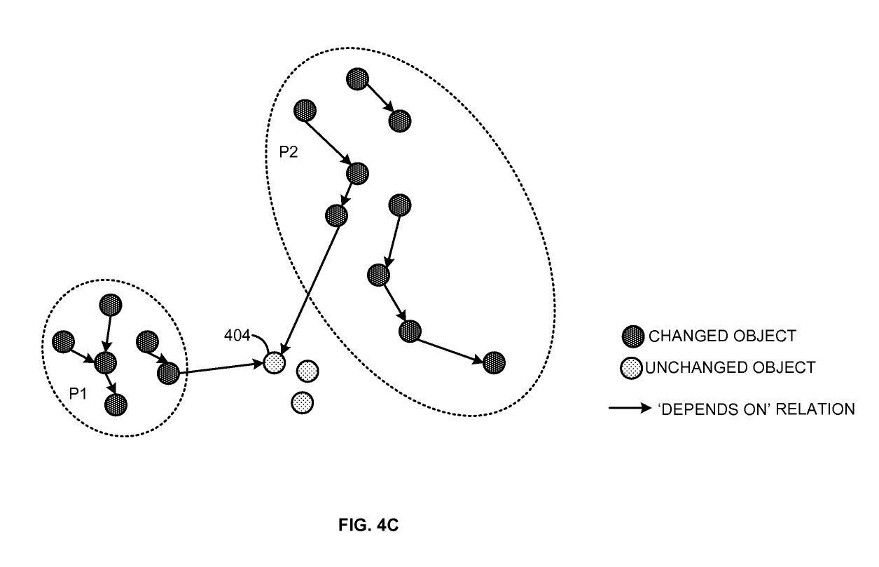

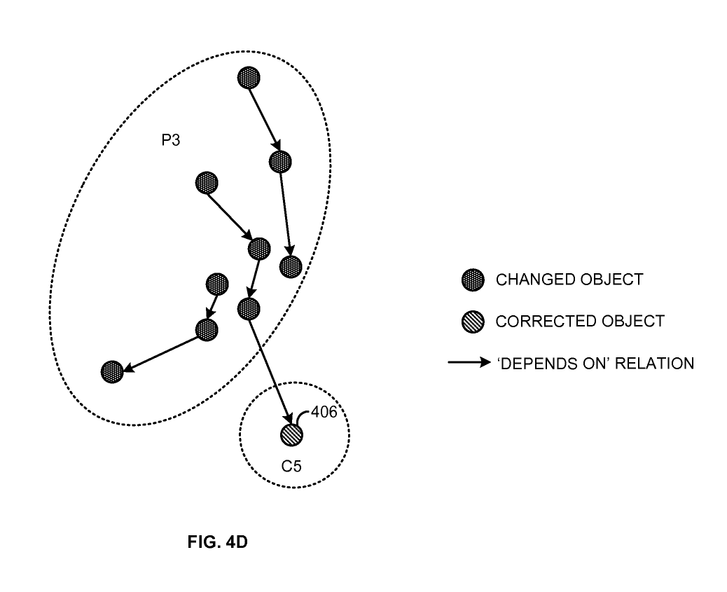

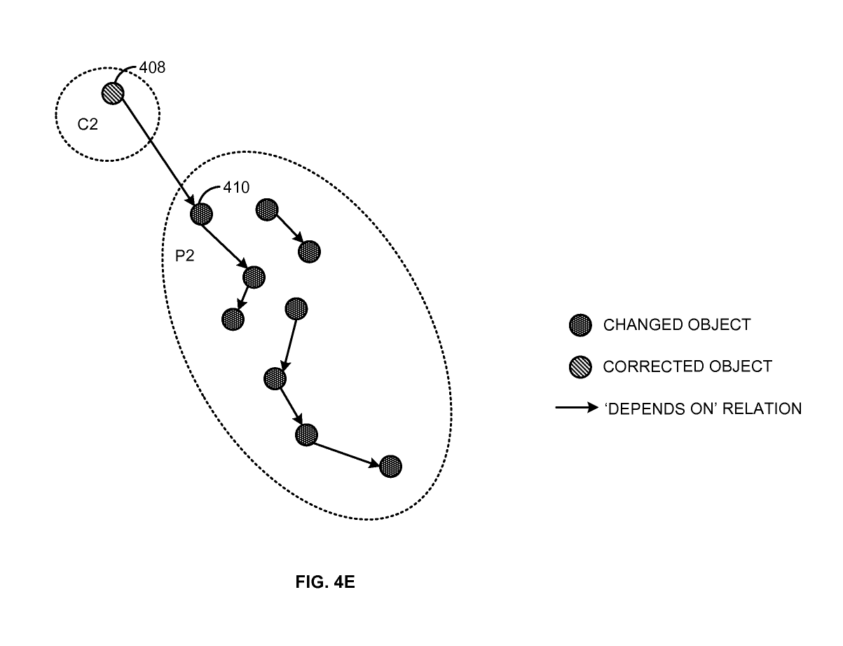

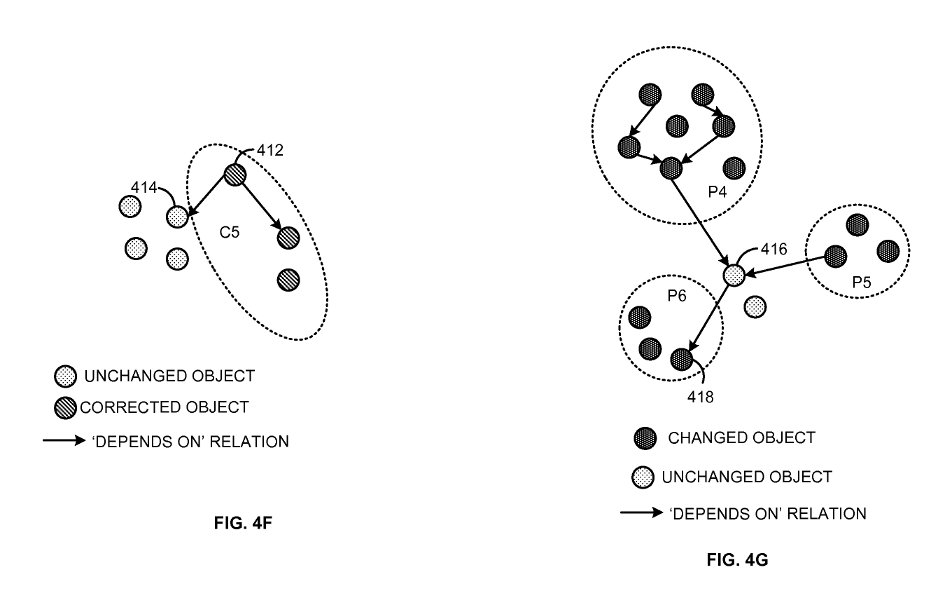

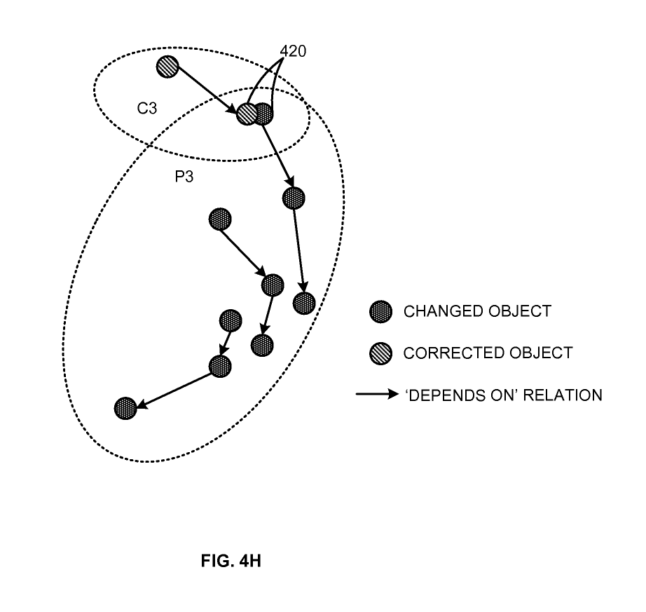

In one embodiment, a third dependency level and a fourth dependency level are assigned to express other degrees of dependency. If one or more development projects depend on a same unchanged development object which depends on another development object changed by another development project, then a third dependency level is assigned to those development projects. Third dependency level can mean that the development projects are related. If two or more development projects use one or more same unchanged development objects, then a fourth dependency level is assigned to those projects. Fourth dependency level can also mean that the development projects are related, but to a lesser degree compared to the third dependency level. Different dependency scenarios and assignment of dependency levels for the dependency scenarios are explained in reference FIGS. 4A-4H.

Project-specific development can be done in development waves. A group of projects are developed in a development wave. Therefore, in one embodiment, development projects belonging to a same development wave and having dependency under first or second dependency levels are assigned to same shipment cluster. But this may not be possible for development projects belonging to different development waves. Therefore, when a development project from a development wave depends on another development project from any previous development wave, an installation precondition is assigned between the development projects. For a precondition assignment, development projects can have dependencies under any of the dependency levels (i.e., first, second, third, or fourth dependency levels). The precondition between development project ‘x’ (Px) belonging to a previous development wave and a development project ‘y’ (Py) from a later development wave mentions that the development project ‘x’ should be installed before installing the development project ‘y.’ Such a precondition will ensure that customers either have the preconditioned development project (e.g., Px) already installed or have to include it into the installation of the depending development project (e.g., Py). If development projects do not have any dependency, then those development projects are not assigned to the same shipment cluster and no installation precondition is assigned between those development projects.

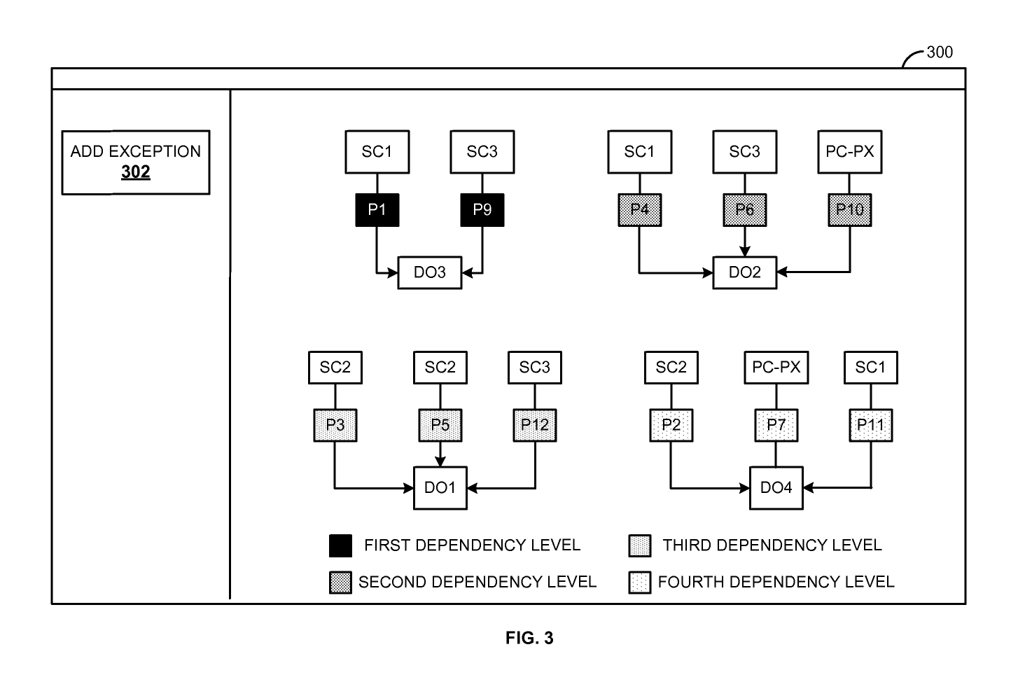

At 208, a list of the development projects, the dependency levels assigned to the development projects, and the development objects causing the dependency are displayed. In one embodiment, shipment cluster assignment for the development projects and installation precondition assignment for the development projects are also displayed. This display is useful for development teams or a developer in several ways. For example, a development team can readily see the dependencies and can try to resolve the dependencies. Various representation schemes can be used for such display. FIG. 3 illustrates one such display, as an example.

Referring to FIG. 3, the development projects, the development objects, the shipment clusters, and installation preconditions can be displayed on a user interface 300 using respective identifiers. For example, development project 1 can be displayed as P1. Similarly, development objects (DO), shipment clusters (SC), and preconditions (PC) are also displayed using respective identifiers. In one embodiment, identifiers used by development teams are used to display the development projects. For example, an identifier “HCM DP 3.0” can be used for a HCM Data Privacy enhancements project. The first, second, third, and fourth dependency levels are expressed using unique graphical identifiers associated with respective development projects. In one embodiment, color-coded identifiers are used. If a first dependency level is assigned to development projects P1 and P9, then P1 and P9 can be displayed on a black background. Similarly, if a second dependency level is assigned to development projects P4, P6, and P10, then P4, P6, and P10 can be displayed on a red background. If a third dependency level is assigned to development projects P3, P5, and P12, then P3, P5, and P12 can be displayed on a yellow background. If a fourth dependency level is assigned to development projects P2, P7, and P11, then P2, P7, and P11 can be displayed on a green background.

The development objects that caused dependency levels are displayed in association with respective development projects. For example, if P1 and P9 depend on development object 3 (DO3), then DO3 is displayed in association with P1 and P9. In one embodiment, an arrow connector can be used to connect P1 and P9 to DO3 to illustrate this dependency. Similarly, development objects DO2 and DO1 that cause second and third dependency, respectively, can be displayed in association with respective projects using arrow connectors. Development object DO4 causing a fourth dependency can be displayed in association with respective projects using line connectors.

The shipment cluster assignment for a development project is displayed in relation to the display of that development project. For example, if the development project P1 is assigned to shipment cluster 1 (SC1), then SC1 is displayed with a line connection to P1. As another example, if the development project P12 is assigned to shipment cluster 3 (SC3), then SC3 is displayed with a line connection to P12. Similarly, a precondition for a development project is displayed in relation to the display of that development project. For example, if a precondition (PC) is assigned between a development project 10 (displayed as P10) belonging to a current development wave and a development project X (PX) belonging to a previous development wave, then PC-PX is displayed with a line connection to P10. In another embodiment (not shown), a shipment cluster assignment can be shown with respect to one or more development objects on which development projects depend. For example, a shipment cluster SC1 can be connected to the development object DO3. In such case, it can be considered that projects P1 and P9 are assigned to shipment cluster SC1.

FIGS. 4A-4H illustrate different dependency scenarios. Referring to FIG. 4A, two development projects P2 and P3 change a same development object 400. Therefore, the development object 400 needs to be delivered with both projects. This development object 400 causes a first level of dependency between both the projects P2 and P3. Also, if both development projects P2 and P3 belong to same development wave, they are assigned to a same shipment cluster. After display of such dependency and shipment cluster assignment, development teams responsible for P2 and P3 can decide whether the assignment to the same shipment cluster is justified or not or if a single sided dependency is sufficient. For example, consider an object is enhanced by a new mandatory element in its interface. The callers of this object have to be adapted accordingly. Assume that there is a caller belonging to P2 and another to P3. As long as these callers are new, i.e., they did not exist before the change in the interface, it is possible to ship P2 independently from P3. But if the callers existed before the change in the interface, the installation of the interface change would make them invalid. In such a case, P2 and P3 have to be shipped/installed together as all adaptations of the callers of the changed interface are needed.

Referring to FIG. 4B, development project P3 depends on a development object 402 changed by development project P4. The development object 402 is changed by only P4 and not by P3. Therefore, there is a lesser degree of dependency compared to the scenario of FIG. 4A and a second dependency level is assigned between development projects P3 and P4. In another scenario as illustrated in FIG. 4C, development projects P1 and P2 depend on a same unchanged development object 404. Therefore, there is a lesser degree of dependency between P1 and P2 compared to the scenarios of FIGS. 4A and 4B and a fourth dependency level is assigned for development projects P1 and P2.

Referring to FIG. 4D, a development project P3 depends on a development object 406 changed by a correction C5. In such a scenario, the correction C5 is also considered as a development project. This scenario is therefore similar to the scenario of FIG. 4B and a second dependency level is assigned between P3 and C5.

Referring to FIG. 4E, a development object 408 changed by a correction C2 depends on a development object 410 changed by a development project P2. The correction C2 is considered as a development project. A second dependency level is assigned between P2 and C2. This type of scenarios may occur when corrections are necessary for already delivered projects. It is therefore likely that P2 belongs to a former development wave and C2 belongs to a later development wave. Therefore, a precondition is assigned between P2 and C2.

Referring to FIG. 4F, a corrected development object 412 of a correction development project C5 depends on an unchanged development object 414. Since the unchanged development object 414 does not belong to any project, there is no dependency for the correction development project C5. In one embodiment, correction development project C5 is displayed without any dependency level assignment.

Referring to FIG. 4G, two development projects P4 and P5 are depending on an unchanged development object 416 which in turn depends on another development object 418 which is changed by development project P6. Therefore, projects P4 and P5 depend on project P6. A third level of dependency is assigned to development projects P4 and P5. Since the unchanged development object 416 further depends on the development object 418 changed by development project P6, the development project P6 is also included in dependency level assignment. Therefore, a third level of dependency is assigned to development projects P4, P5, and P6. Since both projects P4 and P5 depend on project P6, projects P4, P5, and P6 are assigned to the same shipment cluster.

Referring to FIG. 4H, a development object 420 is affected by a correction development project C3 and also by a change caused by a development project P3. The development object 420 should be delivered with both the correction development project C3 and the development project P3. The development object 420 causes a first level of dependency between the development projects C3 and P3. If the correction development project C3 and the development project P3 belong to the same development wave, they are assigned to the same shipment cluster. If the correction development project C3 and the development project P3 belong to different development waves, a precondition is assigned between them.

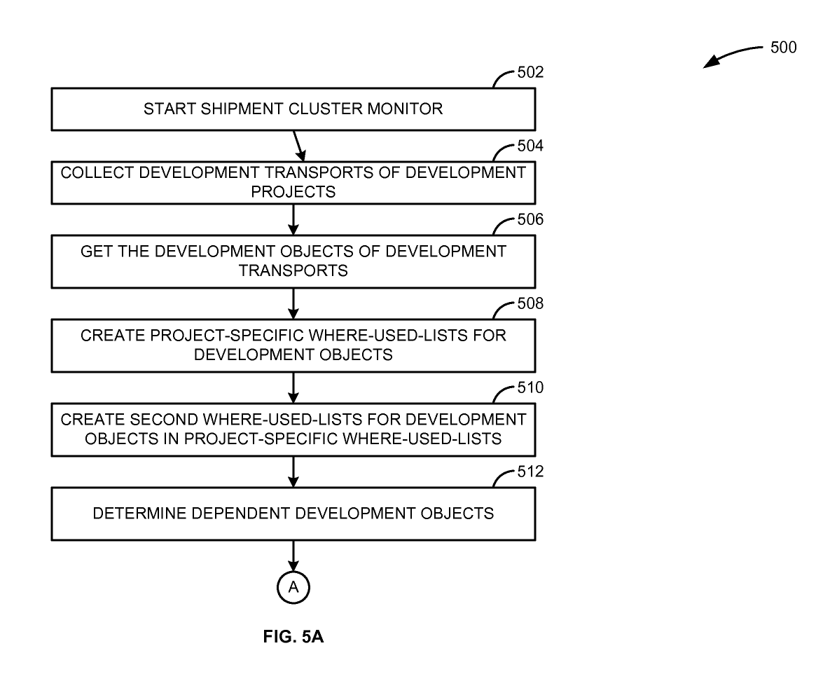

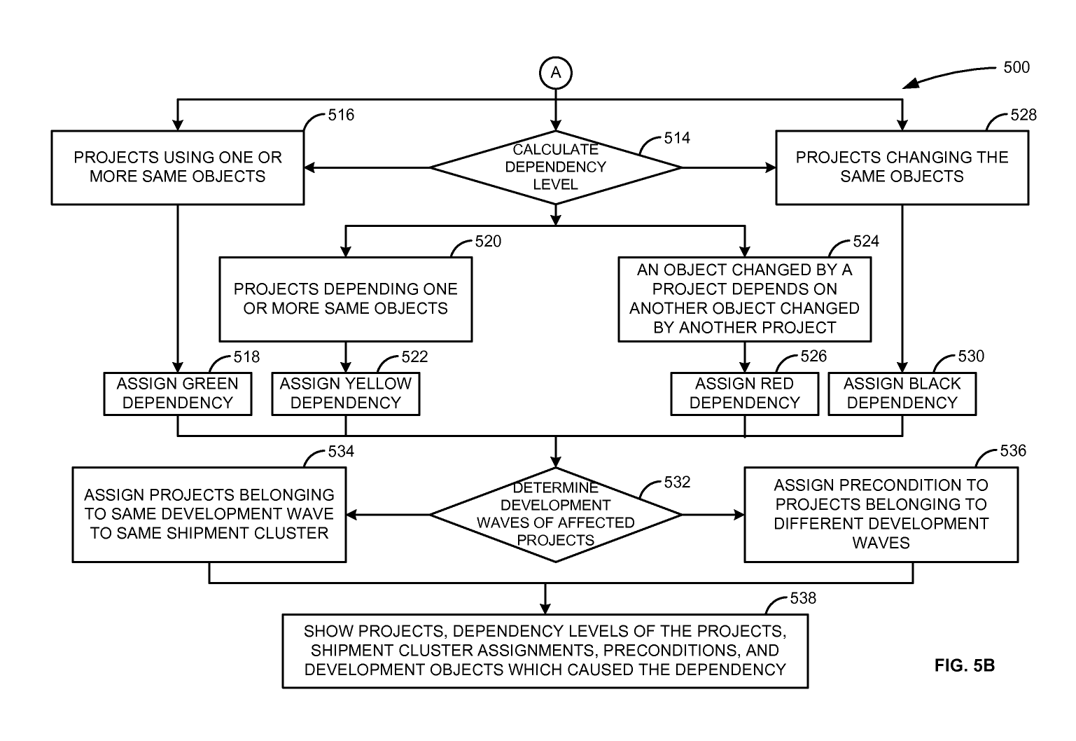

The project-specific delivery method can be embodied in a shipment cluster monitor tool. FIGS. 5A and 5B illustrate a flow diagram 500 of a shipment cluster monitor. In one embodiment, the shipment cluster monitor is integrated with a development system. The shipment cluster monitor can also be integrated with other development-aiding systems such as a testing system and a consolidation system. The shipment cluster monitor is made accessible to development teams. In addition to teams within an organization, development teams can also include partner development teams and customer development teams. Development teams can use the shipment cluster monitor to view development projects, dependency levels of the projects, development objects causing dependency between projects, shipment cluster assignments, and preconditions.

At 502, a member of a development team starts a shipment cluster monitor. In one embodiment, authorized members can logon to start the shipment cluster monitor. Development transports of the development projects are collected at 504. As mentioned previously, development transports are created for development projects. A development transport is required to transport development objects from one development system to another. A development transport includes information about development objects. At 506, development objects of the development transports are obtained. This results in a development object list for each project, e.g., DEV OBJECTS PROJECT X. At 508, project-specific where-used lists for development objects (obtained at 506) are created. This project-specific where-used list includes a list of development objects with respect to development projects to which they belong. At 510, second where-used lists for development objects in the project-specific where-used lists are created. A second where-used list is a collection of development objects used by one or more development objects of a development project. At 512, dependent development objects are determined by comparing project-specific where-used lists and second where-used lists.

Referring to FIG. 5B, dependency levels are then calculated 514. In one embodiment, four dependency levels are used to express various degrees of dependency. Color-coded identifiers are used to represent the dependency levels. If two or more development projects use one or more same unchanged development objects 516, then a fourth dependency level is assigned to those projects at 518. The fourth dependency level is represented by assigning green color to respective projects. If one or more development projects depend on a same unchanged development object 520 which depends on another development object changed by another development project, then a third dependency level is assigned to those development projects at 522. The third dependency level is represented by assigning yellow color to respective projects. If a development object changed by a development project depends on another development object changed by another development project 524, then a second dependency level is assigned to those projects at 526. The second dependency level is represented by assigning red color to respective projects. If two or more development projects changed a same development object 528, then a first dependency level is assigned to those projects at 530. In such case, it may be difficult to cut the dependency. The first dependency level is represented by assigning black color to respective projects.

At 532, a determination of whether the projects belong to same or different development waves is made. If projects belong to same development wave, then those projects are assigned to same shipment cluster at 534. If projects belong to different development waves, then preconditions are assigned between respective projects at 536. At 538, development projects, the dependency levels assigned to the development projects, the development objects causing the dependency, shipment cluster assignment for the development projects, and installation precondition assignments for the development projects are displayed in a user interface 300 (shown in FIG. 3) of the shipment cluster monitor.

During a project development, the shipment cluster monitor shows the current state of the shipment clusters. For the development teams and especially for the product owner, the shipment cluster monitor can be used to get an overview of the dependencies between the development projects, the degrees of dependencies, the development objects that cause dependencies. This will give development teams an opportunity to evaluate the dependencies and try to resolve dependencies to enable an independent shipment. Development teams can make changes to the software to resolve the dependencies. A recalculation of the shipment cluster monitor will show whether a change to software solved a dependency. After a particular dependency is solved, projects that had the particular dependency are no longer assigned to the same shipment cluster or installation precondition.

Development teams can also decide that a dependency caused by a development object as shown in the user interface is not relevant. A corresponding exception can be entered in such a case by an authorized user who decided that the assigned dependency is not justified. An option 302 (shown in FIG. 3) can be provided in the user interface 300 to enter an exception. After an exception is received, the shipment cluster monitor excludes corresponding development objects from a recalculation. However, any new change to the development object under exception will again include that development object into the calculation, thereby canceling the exception. But the exception can be still made visible.

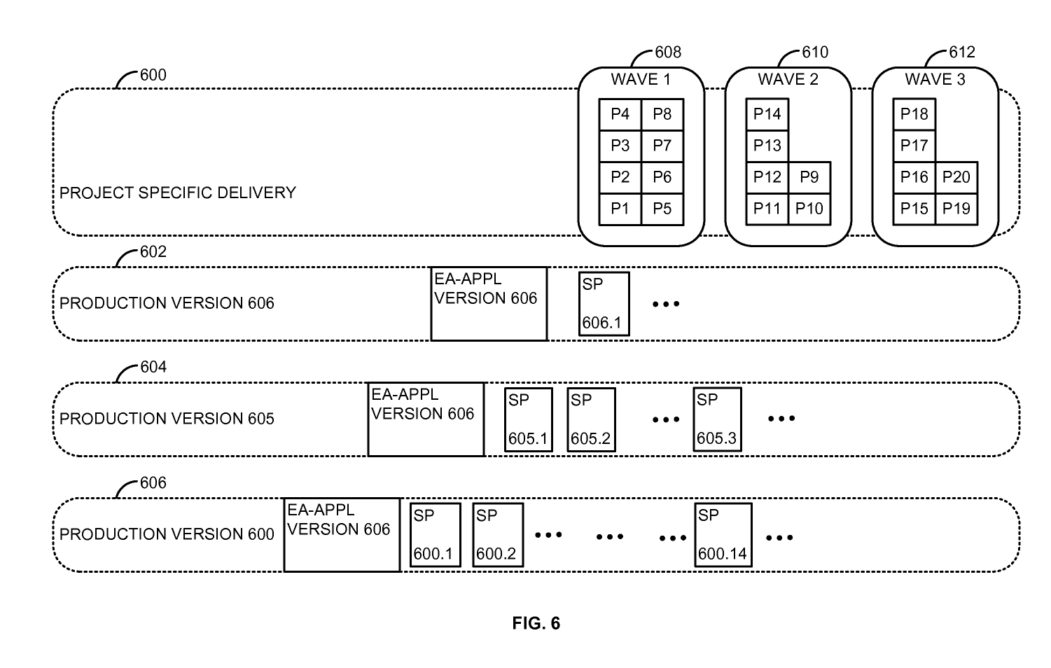

FIG. 6 illustrates a block diagram of project-specific software delivery 600 in comparison with enhancement packages (EHP) 602, 604, and 606, as an example. This figure shows differences between EHP delivery and project specific delivery. Pl-P20 are development projects which can be shipped independently of each other. Compared to enhancement packages 602, 604, and 606, project-specific software delivery 600 offers shipment flexibility. In one embodiment, a development wave concept is used for project-specific development. A group of development projects are developed in each development wave 608, 610, and 612. When one development wave is completed, the next development wave is started with new projects. For example, the second development wave 610 is started after completion of the first development wave 608. Development wave concept may be needed to get a certain order into development landscape and to optimize the processes for software production units.

The project-specific software delivery planning method described above enables development teams to deliver individual development projects embodying new functionalities. There is no need to wait for a common shipment date as in the case of enhancement packages. Each development project team can decide when to deliver new its functionality to customers. Development teams therefore have shipment flexibility. The shipment units will be much smaller and delivery of projects can be non-uniform and more agile.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

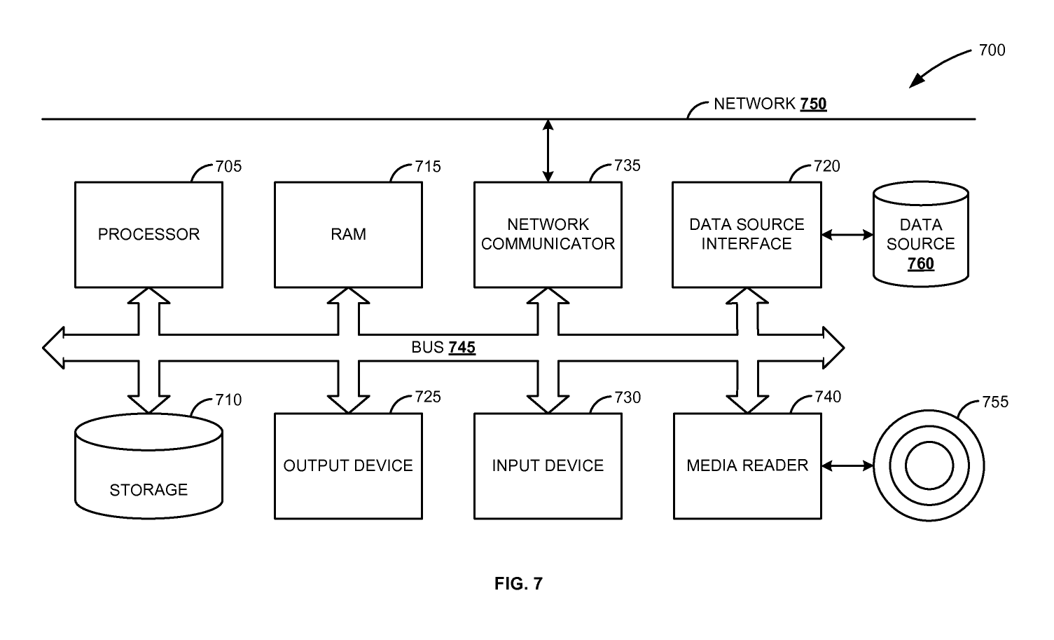

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
determine development objects used by development projects;
determine dependent development objects that depend one or more of the development objects;
assign dependency levels to the development projects based on one or more of the development objects that cause dependency, the dependency levels comprising:
a first dependency level indicating two or more of the development projects changed a same development object; and
a second dependency level indicating a first development object changed by a first development project depends on a second development object changed by a second development project; and
display a list of the development projects, the dependency levels assigned to the development projects, and the development objects causing the dependency.

2. The article of manufacture of claim 1, further comprising instructions which when executed by the computer further causes the computer to:
collect development transports to determine which of the development objects belong to which of the development projects.

3. The article of manufacture of claim 1, further comprising instructions which when executed by the computer further causes the computer to:
assign the development projects to a same shipment cluster if the development projects belong to a same development wave and dependent under the first dependency level or the second dependency level; and
assign an installation precondition between the development projects if the development projects belong to different development waves and dependent under any of the dependency levels.

4. The article of manufacture of claim 3, further comprising instructions which when executed by the computer further causes the computer to:
display the shipment cluster assignment and the installation precondition assignment for the development projects.

5. The article of manufacture of claim 1, wherein the dependency levels further comprises a third dependency level indicating that one or more of the development projects depend on a same unchanged development object which depends on another development object changed by another development project.

6. The article of manufacture of claim 5, wherein the dependency levels further comprises a fourth dependency level indicating that two or more of the development projects use one or more same unchanged development objects.

7. The article of manufacture of claim 6, wherein the instructions to display the dependency levels further comprise instructions to:
display the development projects using unique graphical identifiers representing the dependency levels.

8. The article of manufacture of claim 1, further comprising instructions which when executed by the computer further causes the computer to:
receive an exception to dependency for one or more of the development objects.

9. A computerized method for software delivery planning, the method comprising:
determining development objects used by development projects;
determining dependent development objects that depend on one or more of the development objects;
assigning dependency levels to the development projects based on one or more of the development objects that cause dependency, the dependency levels comprising:
a first dependency level indicating two or more of the development projects changed a same development object; and
a second dependency level indicating a first development object changed by a first development project depends on a second development object changed by a second development project; and
displaying a list of the development projects, the dependency levels assigned to the development projects, and the development objects causing the dependency.

10. The method of claim 9, further comprising:
collecting development transports to determine which of the development objects belong to which of the development projects

11. The method of claim 9, further comprising:
assigning the development projects to a same shipment cluster if the development projects belong to a same development wave and dependent under the first dependency level or the second dependency level; and
assigning an installation precondition between the development projects if the development projects belong to different development waves and dependent under any of the dependency levels.

12. The method of claim 11, further comprising:
displaying the shipment cluster assignment and the installation precondition assignment for the development projects

13. The method of claim 9, wherein the dependency levels further comprises a third dependency level indicating that one or more of the development projects depend on a same unchanged development object which depends on another development object changed by another development project.

14. The method of claim 13, wherein the dependency levels further comprises a fourth dependency level indicating that two or more of the development projects use one or more same unchanged development objects.

15. The method of claim 14, wherein displaying the dependency levels comprises:
displaying the development projects using unique graphical identifiers representing the dependency levels.

16. The method of claim 9, further comprising:
receiving an exception to dependency for one or more of the development objects.

17. A computer system for software delivery planning, comprising:
a computer memory to store program code; and
a processor to execute the program code to:
determine development objects used by development projects;
determine dependent development objects that depend one or more of the development objects;
assign dependency levels to the development projects based on one or more of the development objects that cause dependency, the dependency levels comprising:
a first dependency level indicating two or more of the development projects changed a same development object; and
a second dependency level indicating a first development object changed by a first development project depends on a second development object changed by a second development project; and
display a list of the development projects, the dependency levels assigned to the development projects, and the development objects causing the dependency.

18. The system of claim 17, wherein the processor further executes the program code to:
collect development transports to determine which of the development objects belong to which of the development projects.

19. The system of claim 17, wherein the processor further executes the program code to:
assign the development projects to a same shipment cluster if the development projects belong to a same development wave and dependent under the first dependency level or the second dependency level;
assign an installation precondition between the development projects if the development projects belong to different development waves and dependent under any of the dependency levels; and
display the shipment cluster assignment and the installation precondition assignment for the development projects.

20. The system of claim 17, wherein the dependency levels further comprise a third dependency level indicating that one or more of the development projects depend on a same unchanged development object which depends on another development object changed by another development project and a fourth dependency level indicating that two or more of the development projects use one or more same unchanged development objects.

21. The system of claim 20, wherein the program code to display the dependency levels, further comprises program code to:
display the development projects using unique graphical identifiers representing the dependency levels.

22. The system of claim 17, wherein the processor further executes the program code to:
receive an exception to dependency for one or more of the development objects.
